(19) United States
(12) Patent Application Publication
(10) Pub. No.: US 2010/0240364 A1
(43) Pub. Date: Sep. 23, 2010

(54) METHODS AND APPARATUS FOR BROADCASTING SYSTEM OVERHEAD MESSAGES IN WIRELESSS COMMUNICATION SYSTEMS

(75) Inventors: Tom Chin, San Diego, CA (US); Guangming Carl Shi, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/405,230

(22) Filed: Mar. 17, 2009

(51) Int. Cl. H04W 4/00; H04M 1/00

(52) U.S. Cl. 455/434; 455/561

(57) ABSTRACT

A base station may generate a subpacket of system overhead messages that is designed so that a subscriber station improves a success rate of decoding the system overhead messages by accumulating multiple received subpackets. The base station may repeatedly broadcast the subpacket to subscriber stations. When a subscriber station receives a subpacket of system overhead messages, the subscriber station may combine the subpacket with previously received subpackets and attempt to decode the system overhead messages from this combination.

### TECHNICAL FIELD

The present disclosure relates generally to communication systems. More specifically, the present disclosure relates to methods and apparatus for broadcasting system overhead messages in wireless communication systems.

### SUMMARY

In certain embodiments, a method for broadcasting system overhead messages is disclosed. The method may be implemented by a base station. In accordance with the method, the base station may generate a subpacket of system overhead messages that is designed so that a subscriber station improves a success rate of decoding the system overhead messages by accumulating multiple received subpackets. The base station may repeatedly broadcast the subpacket to subscriber stations.

In certain embodiments, a method for receiving system overhead messages is disclosed. The method may be implemented by a subscriber station. In accordance with the method, the subscriber station may combine a received subpacket of system overhead messages and one or more previously received subpackets of the system overhead messages. The subscriber station may attempt to decode the system overhead messages from the combination of the received subpacket of the system overhead messages and one or more previously received subpackets of the system overhead messages.

In certain embodiments, a base station configured for broadcasting system overhead messages is disclosed. The base station includes a processor, memory in electronic communication with the processor, and instructions stored in the memory. The instructions may be executable by the processor to generate a subpacket of system overhead messages that is designed so that a subscriber station improves a success rate of decoding the system overhead messages by accumulating multiple received subpackets. The instructions may also be executable to repeatedly broadcast the subpacket to subscriber stations.

In certain embodiments, a subscriber station configured for receiving system overhead messages is disclosed. The subscriber station includes a processor, memory in electronic communication with the processor, and instructions stored in the memory. The instructions may be executable by the processor to combine a received subpacket of system overhead messages and one or more previously received subpackets of the system overhead messages. The instructions may also be executable to attempt to decode the system overhead messages from the combination of the received subpacket of the system overhead messages and one or more previously received subpackets of the system overhead messages.

In certain embodiments, a base station configured for broadcasting system overhead messages is disclosed. The base station may include means for generating a subpacket of system overhead messages that is designed so that a subscriber station improves a success rate of decoding the system overhead messages by accumulating multiple received subpackets. The base station may also include means for repeatedly broadcasting the subpacket to subscriber stations.

In certain embodiments, a subscriber station configured for receiving system overhead messages is disclosed. The subscriber station may include means for combining a received subpacket of system overhead messages and one or more previously received subpackets of the system overhead messages. The subscriber station may also include means for attempting to decode the system overhead messages from the combination of the received subpacket of the system overhead messages and one or more previously received subpackets of the system overhead messages.

In certain embodiments, a computer-program product for a base station to broadcast system overhead messages is disclosed. The computer-program product includes a computer-readable medium having instructions thereon. The instructions may include code for generating a subpacket of system overhead messages that is designed so that a subscriber station improves a success rate of decoding the system overhead messages by accumulating multiple received subpackets. The instructions may also include code for repeatedly broadcasting the subpacket to subscriber stations.

In certain embodiments, a computer-program product for a subscriber station to receive system overhead messages is disclosed. The computer-program product includes a computer-readable medium having instructions thereon. The instructions may include code for combining a received subpacket of system overhead messages and one or more previously received subpackets of the system overhead messages. The instructions may also include code for attempting to decode the system overhead messages from the combination of the received subpacket of the system overhead messages and one or more previously received subpackets of the system overhead messages.

In certain embodiments, as presented in the summary paragraphs above and elsewhere in this application, the base station can support an Institute of Electronic and Electrical Engineers (IEEE) 802.16 standard and/or the subscriber station can support an Institute of Electronic and Electrical Engineers (IEEE) 802.16 standard.

### BRIEF DESCRIPTION OF THE DRAWINGS

FIG. 1 shows an example of wireless communication system in which the methods and apparatus disclosed herein may be utilized;

FIG. 2 illustrates a base station that is configured to broadcast system overhead messages in accordance with the present disclosure;

FIG. 3 illustrates an example showing how the base station, nearby subscriber station and distant subscriber station may operate in accordance with the system overhead broadcast scheme proposed herein;

FIG. 4 illustrates an example showing how the base station, nearby subscriber station and distant subscriber station may operate in accordance with the existing system overhead broadcast scheme;

FIG. 5 illustrates a new type of DL-MAP information element (IE) in accordance with the present disclosure;

FIG. 6 illustrates information that may be included within the new DL-MAP IE;

FIG. 7 illustrates a method for receiving system overhead messages;

FIG. 8 illustrates means-plus-function blocks corresponding to the method of FIG. 7; and

FIG. 9 illustrates certain components that may be included within a wireless device.

### DETAILED DESCRIPTION

Wireless communication systems have become an important means by which many people worldwide have come to communicate. A wireless communication system may provide communication for a number of subscriber stations, each of which may be serviced by a base station. As used herein, the term “subscriber station” refers to an electronic device that may be used for voice and/or data communication over a wireless communication system. Examples of subscriber stations include cellular phones, personal digital assistants (PDAs), handheld devices, wireless modems, laptop computers, personal computers, etc. A subscriber station may alternatively be referred to as an access terminal, a mobile terminal, a mobile station, a remote station, a user terminal, a terminal, a subscriber unit, a mobile device, a wireless device, user equipment, or some other similar terminology. The term “base station” refers to a wireless communication station that is installed at a fixed location and used to communicate with subscriber stations. A base station may alternatively be referred to as an access point, a Node B, an evolved Node B, or some other similar terminology.

A subscriber station may communicate with one or more base stations via transmissions on the uplink and the downlink. The uplink (or reverse link) refers to the communication link from the subscriber station to the base station, and the downlink (or forward link) refers to the communication link from the base station to the subscriber station.

The resources of a wireless communication system (e.g., bandwidth and transmit power) may be shared among multiple subscriber stations. A variety of multiple access techniques are known, including code division multiple access (CDMA), time division multiple access (TDMA), frequency division multiple access (FDMA), orthogonal frequency division multiple access (OFDMA), single-carrier frequency division multiple access (SC-FDMA), and so forth.

Benefits may be realized by improved methods and apparatus related to the operation of wireless communication systems.

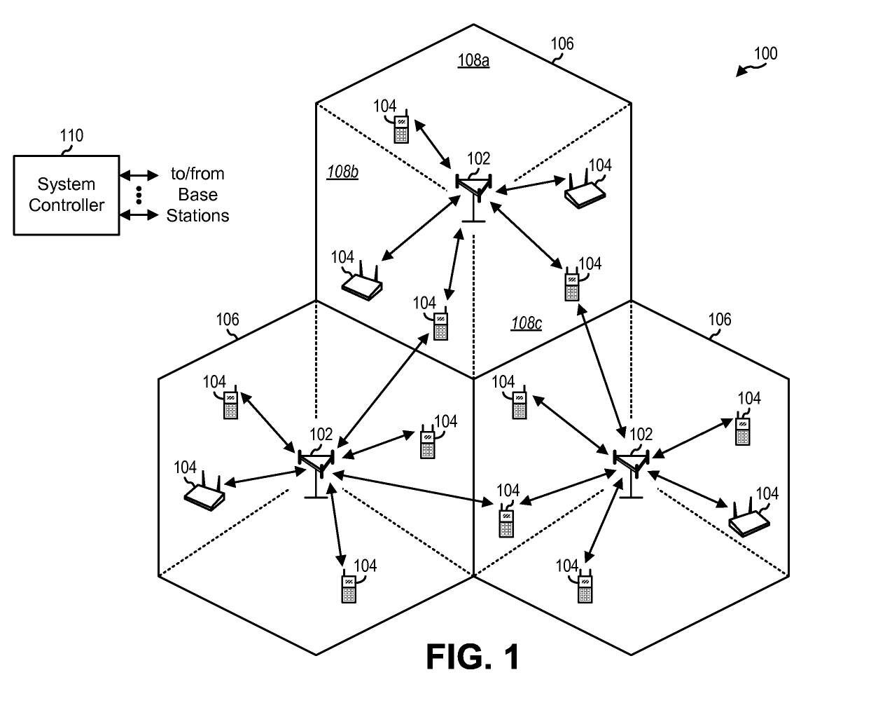

FIG. 1 shows an example of a wireless communication system 100 in which the methods and apparatus disclosed herein may be utilized. The wireless communication system 100 includes multiple base stations (BS) 102 and multiple subscriber stations (SS) 104. Each base station 102 provides communication coverage for a particular geographic area 106. The term “cell” can refer to a base station 102 and/or its coverage area 106 depending on the context in which the term is used.

To improve system capacity, a base station coverage area 106 may be partitioned into multiple smaller areas, e.g., three smaller areas 108a, 108b, and 108c. Each smaller area 108a, 108b, 108c may be served by a respective base transceiver station (BTS). The term “sector” can refer to a BTS and/or its coverage area 108 depending on the context in which the term is used. For a sectorized cell, the BTSs for all sectors of that cell are typically co-located within the base station 102 for the cell.

Subscriber stations 104 are typically dispersed throughout the system 100. A subscriber station 104 may communicate with zero, one, or multiple base stations 104 on the downlink and/or uplink at any given moment.

For a centralized architecture, a system controller 110 may couple to the base stations 102 and provide coordination and control for the base stations 102. The system controller 110 may be a single network entity or a collection of network entities. For a distributed architecture, base stations 102 may communicate with one another as needed.

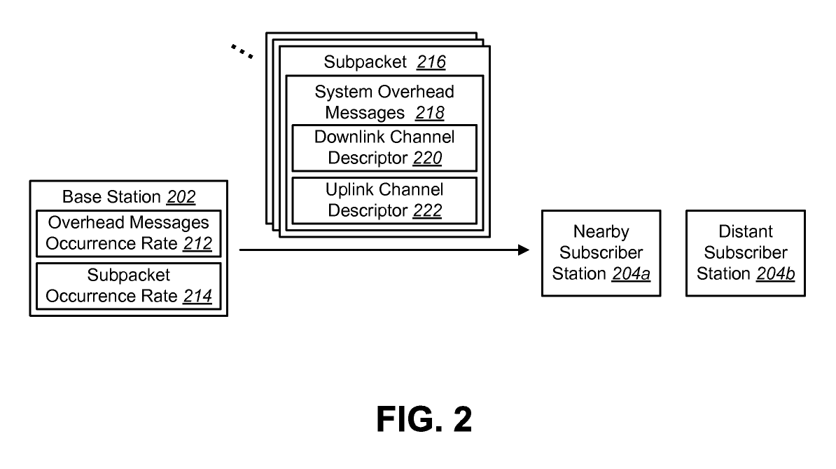

FIG. 2 illustrates a base station 202 that is configured to broadcast system overhead messages 218 in accordance with the present disclosure. FIG. 2 also illustrates subscriber stations 204 that are configured to receive system overhead messages 218 in accordance with the present disclosure. The base station 202 may be similar to a base station 102 in the wireless communication system 100 shown in FIG. 1. Each subscriber station 204 may be similar to a subscriber station 104 in the wireless communication system 100 shown in FIG. 1.

The base station 202 and the subscriber stations 204 may be configured to support an Institute of Electronic and Electrical Engineers (IEEE) 802.16 standard. The IEEE 802.16 family of standards has been called “WiMAX,” which stands for the “Worldwide Interoperability for Microwave Access.” The base station 202 may include various modules/data for supporting a WiMAX standard. Similarly, the subscriber stations 204 may also include various modules/data for supporting a WiMAX standard.

The base station 202 may broadcast system overhead messages 218 to subscriber stations 204. In a WiMAX system, examples of system overhead messages 218 include the Downlink Channel Descriptor (DCD) 220 and the Uplink Channel Descriptor (UCD) 222. The DCD 220 may include information about the physical layer characteristics of the downlink channel. Similarly, the UCD 222 may include information about the physical layer characteristics of the uplink channel.

System overhead messages 218 may be broadcast periodically. A rate of occurrence for the system overhead messages 218 may be defined. This may be referred to herein as the overhead messages occurrence rate 212. The overhead messages occurrence rate 212 may indicate how frequently the system overhead messages 218 should be broadcast to subscriber stations 204 (e.g., how many times the system overhead messages 218 should be broadcast to subscriber stations 204 within a given time period) in accordance with current WiMAX standards. The overhead messages occurrence rate 212 may be stored by the base station 202.

In the present discussion, the term “nearby subscriber station” may refer to a subscriber station 204a that is located relatively close to the base station 202. The term “distant subscriber station” may refer to a subscriber station 204b that is located relatively far away from the base station 202 (e.g., at or near the edge of the coverage area of the base station 202). Both a nearby subscriber station 204a and a distant subscriber station 204b are shown in FIG. 2.

System overhead messages 218 may be broadcast to subscriber stations 204 using a very robust modulation and coding scheme (e.g., repetition coding) in order to be correctly received by distant subscriber stations 204b. If a robust modulation and coding scheme is used, it may take a significant amount of time to broadcast system overhead messages 218. The amount of time that it takes to broadcast system overhead messages 218 may be referred to herein as the overhead message interval. Current WiMAX standards indicate that the overhead message interval may be as long as 10 seconds.

The longer the overhead message interval, the longer the system acquisition time for a subscriber station 204. The present disclosure relates generally to techniques for broadcasting system overhead messages 218 in order to speed up system acquisition. Advantageously, the techniques disclosed herein may speed up system acquisition while utilizing approximately the same amount of time-averaged bandwidth as current approaches for broadcasting system overhead messages 218.

In accordance with the present disclosure, a subpacket 216 of the system overhead messages 218 may be generated and repeatedly broadcast to subscriber stations 204. In this context the term “subpacket” 216 is used to indicate that less bandwidth is required to transmit the subpacket 216 of the system overhead messages 218 than to transmit the system overhead messages 218 themselves.

The subpacket 216 may be designed so that a subscriber station 204 improves a success rate of decoding the system overhead messages 218 by accumulating multiple received subpackets 216. For example, a chase combining scheme may be used. Chase combining is a technique whereby a receiver can combine signals, OFDMA symbol-subcarrier-wise, of multiple received identical subpackets. For example, if a subscriber station 204 receives a subpacket at the i-th transmission with signal S(i,j) for the j-th OFDMA symbol-subcarrier, then the subscriber station 204 can combine these signals linearly to get a composite signal as

$$S ( j ) = {\sum }_{i} a ( i ) * S ( i , j ) ,$$

whereby the time diversity gain can be achieved and the error rate is reduced. The parameter a(i) is the weight or gain for combining. Some well-known algorithms are available to determine the weight, such as Maximum Ratio Combining (MRC).

Without the subpackets 216 proposed herein, the channel descriptor messages 220, 222 may be sent using, for example, repetition coding in order for the most distant subscriber station 204 to receive the channel descriptor messages 220, 222. In contrast, the subpacket 216 concept proposed herein does not need any repetition and can use a less robust modulation and coding scheme to save bandwidth in sending each subpacket 216. Let us assume that a distant subscriber station 204 can decode the channel descriptor messages 220, 222 after receiving n subpackets. In this case, the time average bandwidth is similar to the existing message broadcast with the amount of repetition equal to n. But, for the nearby subscriber station 204, after it receives the first subpacket 216 or the second subpacket 216, it may decode the messages 220, 222 successfully, thereby reducing the acquisition time.

When a subscriber station 204 receives a subpacket 216, the subscriber station 204 may combine the subpacket 216 with any previously received subpackets 216, and attempt to decode the system overhead messages 218 from the resulting combination. For example, when a subscriber station 204 receives a first subpacket 216, the subscriber station 204 may attempt to decode the system overhead messages 218 from the first subpacket 216. If the subscriber station 204 is not able to decode the system overhead messages 218 from the first subpacket 216, then when the subscriber station 204 receives a second subpacket 216, the subscriber station 204 may combine the first subpacket 216 and the second subpacket 216 and attempt to decode the system overhead messages 218 from the resulting combination. If the subscriber station 204 is not able to decode the system overhead messages 218 from the combination of the first subpacket 216 and the second subpacket 216, then when the subscriber station 204 receives a third subpacket 216, the subscriber station 204 may combine the first, second and third subpackets 216 and attempt to decode the system overhead messages 218 from the resulting combination. This process may continue in this manner until enough subpackets 216 have been received for the subscriber station 204 to be able to decode the system overhead messages 218.

A rate of occurrence 214 for the subpacket 216 may be defined. This may be referred to herein as the subpacket occurrence rate 214. The subpacket occurrence rate 214 may indicate how frequently the subpacket 216 should be broadcast to subscriber stations 204 (e.g., how many times the subpacket 216 should be broadcast to subscriber stations 204 within a given time period). The subpacket occurrence rate 214 may be stored by the base station 202. The subpacket occurrence rate 214 may be higher than the overhead messages occurrence rate 212 discussed above. In other words, the subpacket 216 may be broadcast more frequently than the system overhead messages 218 are broadcast in accordance with current WiMAX standards.

The techniques disclosed herein may make it possible for a nearby subscriber station 204a to decode the system overhead messages 218 more quickly than with current approaches. This is because a nearby subscriber station 204a may be able to decode the system overhead messages 218 after receiving just one or two subpackets 216, and, as indicated above, subpackets 216 may be broadcast more frequently than the system overhead messages 218 are broadcast in accordance with current WiMAX standards. Thus, for a nearby subscriber station 204a, the techniques disclosed herein may result in a system acquisition time that is less than the existing system overhead broadcast scheme.

A distant subscriber station 204b may need to receive more subpackets 216 than a nearby subscriber station 204a in order to be able to decode the system overhead messages 218. The additional subpackets 216 may be needed in order to compensate for the greater propagation loss. Thus, for a distant subscriber station 204b, the techniques disclosed herein may result in a system acquisition time that is similar to the existing system overhead broadcast scheme.

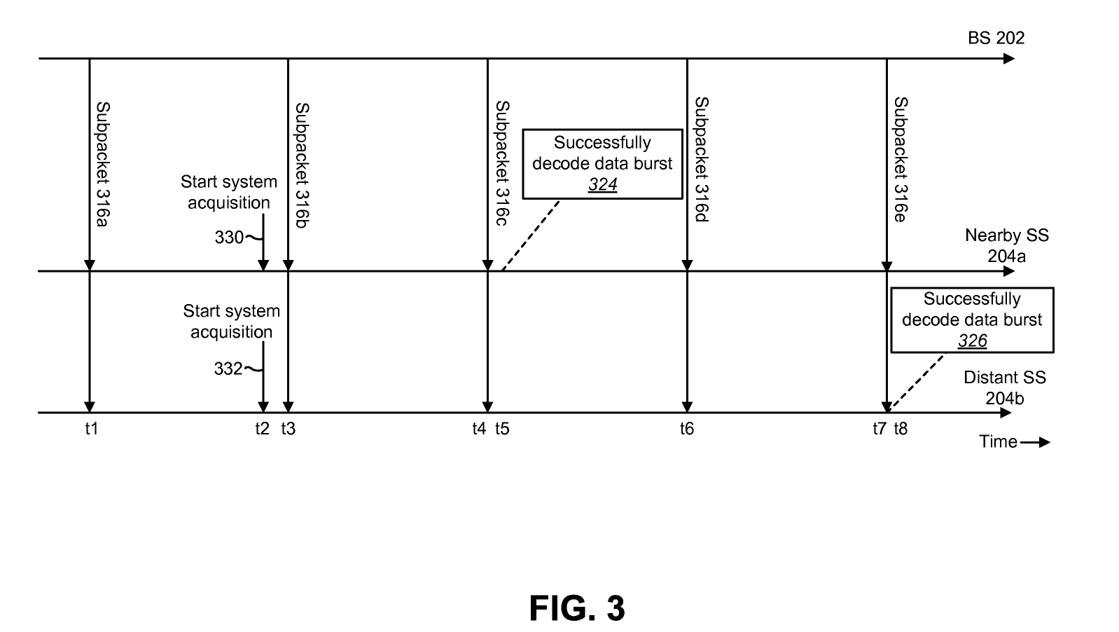

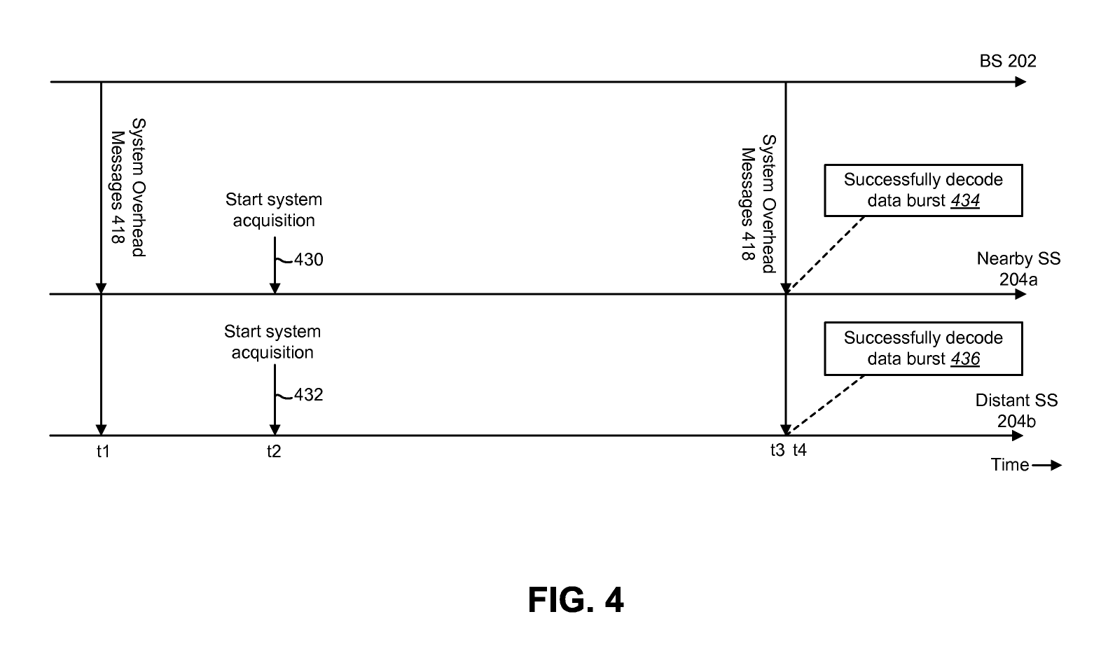

FIGS. 3 and 4 compare the system overhead broadcast scheme proposed herein with the existing system overhead broadcast scheme.

FIG. 3 illustrates an example showing how the base station 202, nearby subscriber station 204a and distant subscriber station 204b may operate in accordance with the system overhead broadcast scheme proposed herein.

At time t1, the base station 202 may broadcast a first subpacket 316a to the subscriber stations 204. At time t2, both the nearby subscriber station 204a and the distant subscriber station 204b may start 330, 332 system acquisition. At time t3, the base station 202 may broadcast a second subpacket 316b to the subscriber stations 204. At time t4, the base station 202 may broadcast a third subpacket 316c to the subscriber stations 204. At time t5, the nearby subscriber station 204a may successfully decode 324 the system overhead messages 218 from the combination of the second and third subpackets 316b, 316c. At time t6, the base station 202 may broadcast a fourth subpacket 316d to the subscriber stations 204. At time t7, the base station 202 may broadcast a fifth subpacket 316e to the subscriber stations 204. At time t8, the distant subscriber station 204b may successfully decode 326 the system overhead messages 218 from the combination of the second, third, fourth and fifth subpackets 316b, 316c, 316d, 316e.

FIG. 4 illustrates an example showing how the base station 202, nearby subscriber station 204a and distant subscriber station 204b may operate in accordance with the existing system overhead broadcast scheme.

At time t1, the base station 202 may broadcast system overhead messages 418 to the subscriber stations 204 for the first time. At time t2, both the nearby subscriber station 204a and the distant subscriber station 204b may start 430, 432 system acquisition. At time t3, the base station 202 may broadcast system overhead messages 418 to the subscriber stations 204 for the second time. At time t4, both the nearby subscriber station 204a and the distant subscriber station 204b may successfully decode 434, 436 the system overhead messages 418.

In comparing the example shown in FIG. 3 (which illustrates the system overhead broadcast scheme proposed herein) with the example shown in FIG. 4 (which illustrates the existing system overhead broadcast scheme), it may be seen that the system acquisition time for the nearby subscriber station 204a in the system overhead broadcast scheme proposed herein is less than the system acquisition time for the nearby subscriber station 204a in the existing system overhead broadcast scheme. The system acquisition time for the distant subscriber station 204b in the system overhead broadcast scheme proposed herein is about the same as the system acquisition time for the distant subscriber station 204b in the existing system overhead broadcast scheme.

In addition, both approaches utilize approximately the same amount of time-averaged bandwidth. As discussed above, with the system overhead broadcast scheme proposed herein, subpackets 216 may be broadcast more frequently than the system overhead messages 218 are broadcast in the existing system overhead broadcast scheme. However, less bandwidth is required to transmit the subpacket 216 of the system overhead messages 218 than to transmit the system overhead messages 218 themselves because the subscriber station 204 can accumulate a few subpackets 216 to decode the system overhead message 218 successfully with each subpacket 216 being transmitted with a less robust modulation and coding scheme and a higher information rate to save bandwidth.

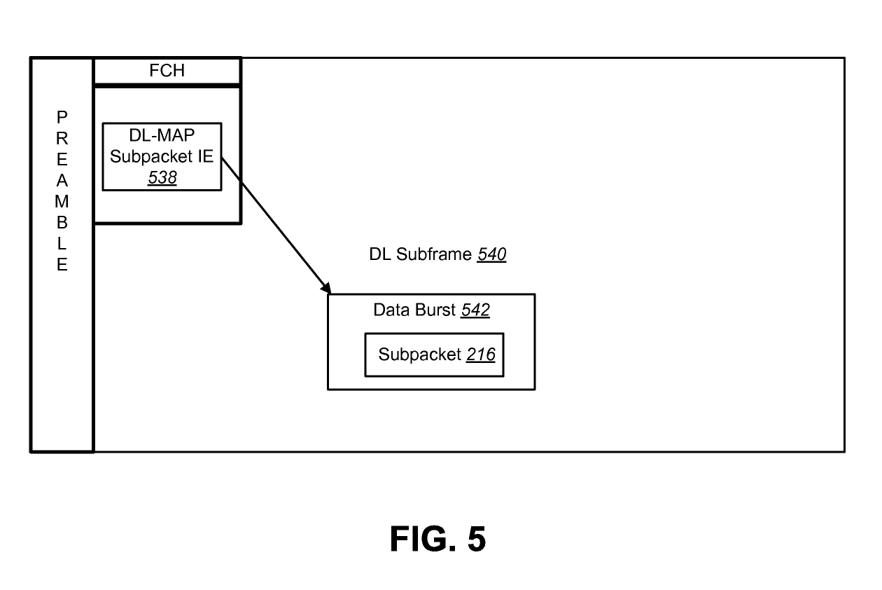

FIG. 5 illustrates a new type of DL-MAP information element (IE) 538 in accordance with the present disclosure. In a WiMAX system, an information element is an element of a medium access control (MAC) message. A DL-MAP IE describes one burst profile. The DL-MAP IE 538 proposed herein may be transmitted by a base station 202 in order to identify a data burst 542 within a downlink subframe 540 in which the subpacket 216 is transmitted. The DL-MAP IE 538 proposed herein may be referred to as a DL-MAP subpacket IE 538.

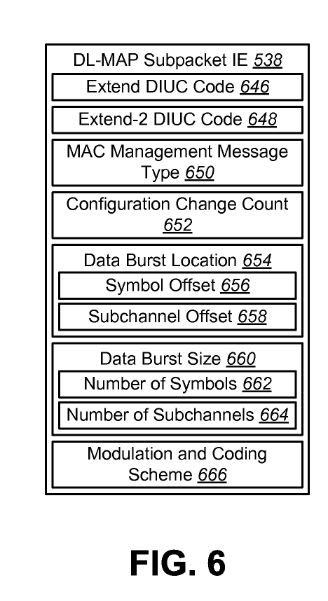

FIG. 6 illustrates information that may be included within a DL-MAP subpacket IE 538. The DL-MAP subpacket IE 538 may be identified by a new extended downlink interval usage code (DIUC) 646 or an extended-2 DIUC 648 to indicate that it is the subpacket 216 for the broadcast of system overhead messages 218. In other words, the extended DIUC 646 or extended-2 DIUC 648 may be uniquely associated with the broadcasting of system overhead messages 218.

In a WiMAX system, a burst 542 is a collection of slots having the same type of MCS (modulation and coding scheme). When assigning a burst 542 to a subscriber station 204 in the uplink or downlink, this information (MCS) is communicated to the subscriber station 204 so that the subscriber station 204 can modulate or demodulate the burst 542 assigned by the base station 202 for uplink or downlink transmission. The base station 202 informs the subscriber station 204 of the assigned burst type by a number, called the interval usage code. The burst profile in the downlink burst assignment is communicated through a downlink interval usage code (DIUC).

DIUC is a 4-bit field that can indicate up to 16 different DL-MAP IE types. However, there are more than 16 IE types being defined in WiMAX standards. Therefore DIUC=15, 14 are used to extend the IE type definition. If a subscriber station 204 sees the DIUC=15, the subscriber station 204 checks the next 4 bits following the DIUC field to see the actual IE type. When DIUC=15, the next 4-bit field is called the Extended DIUC field. When DIUC=14, the next 4-bit field is called the Extended-2 DIUC field. To identify the new DL-MAP subpacket IE 538 being proposed herein, DIUC may be set equal to 14, and the Extended-2 DIUC may be set equal to a value not yet allocated by WiMAX standards.

The DL-MAP subpacket IE 538 may include the MAC management message type 650. The MAC management message type 650 may indicate whether the corresponding subpacket 216 (i.e., the subpacket 216 that is transmitted in the data burst 542 that the DL-MAP identifies) includes a DCD 220, UCD 222, etc.

The DL-MAP subpacket IE 538 may also include the configuration change count 652. Each DCD 220 or UCD 222 has a corresponding version, called DCD 220 or UCD 222 configuration change count, respectively. If there is any change in the DCD 220 (or UCD 222), the DCD 220 (or UCD 222) configuration change count should increment. Therefore, if the subscriber station 204 has previously acquired a DCD 220 (or UCD 222) with the same configuration change count as indicated by the DL-MAP subpacket IE 538, then the subscriber station 204 may not bother to receive the subpacket(s) 216 to decode the message 218. Otherwise, if the two counts are different, the subscriber station 204 should receive the subpacket 216 (and accumulate subpackets 216 if needed) in order to decode the message 218 successfully.

The DL-MAP subpacket IE 538 may also include the location 654 of the data burst 542 that includes the subpacket 216. The data burst location 654 may be identified by symbol offset 656 and subchannel offset 658.

The DL-MAP subpacket IE 538 may also include the size 660 of the data burst 542 that includes the subpacket 216. The data burst size 660 may be identified by the number of symbols 662 and the number of subchannels 664.

The DL-MAP subpacket IE 538 may also include the modulation and coding scheme 666 of the data burst 542 that includes the subpacket 216.

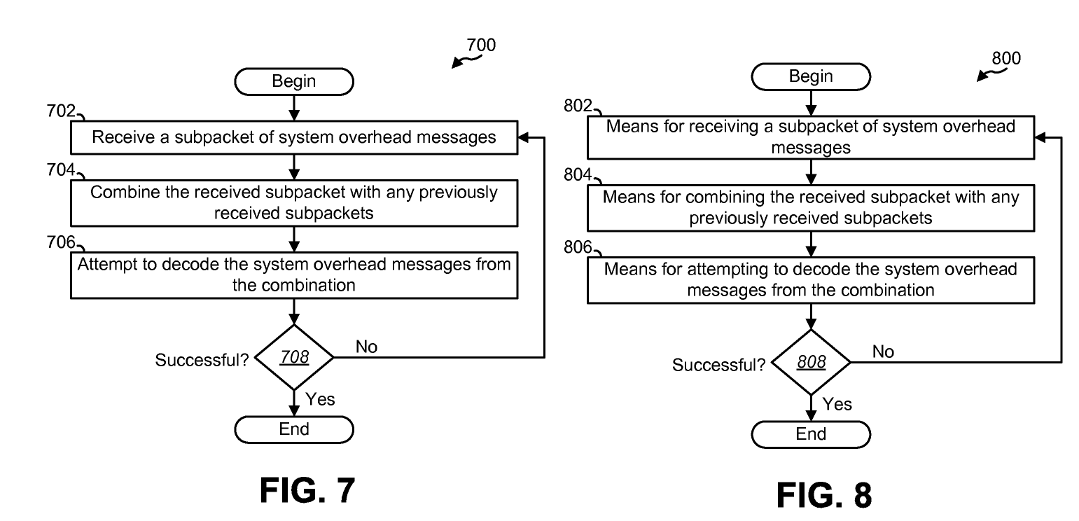

FIG. 7 illustrates a method 700 for receiving system overhead messages 218. The method 700 may be implemented by a subscriber station 204.

As part of the method 700, a subscriber station 204 may receive 702 a subpacket 216 of system overhead messages 218. The subscriber station 204 may combine 704 the received subpacket 216 of system overhead messages 218 with previously received subpackets 216 of system overhead messages 218 (if any).

The subscriber station 204 may attempt 706 to decode the system overhead messages 218 from the combination of the most recently received subpacket 216 of system overhead messages 218 and any previously received subpackets 216 of system overhead messages 218. If decoding is unsuccessful 708, then the subscriber station 204 may wait to receive 702 another subpacket 216 of system overhead messages 218, and the method 700 may continue in the manner described above.

The method 700 of FIG. 7 described above may be performed by various hardware and/or software component(s) and/or module(s) corresponding to the means-plus-function blocks 800 illustrated in FIG. 8. In other words, blocks 702 through 708 illustrated in FIG. 7 correspond to means-plus-function blocks 802 through 808 illustrated in FIG. 8.

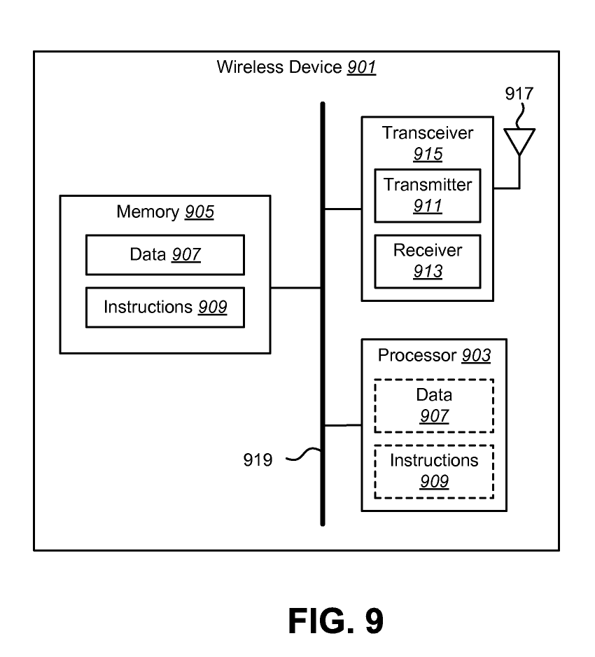

FIG. 9 illustrates certain components that may be included within a wireless device 901. The wireless device 901 may be a subscriber station 204 or a base station 202.

The wireless device 901 includes a processor 903. The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the wireless device 901 of FIG. 9, in an alternative configuration, a combination of processors (e.g., an ARM and DSP) could be used.

The wireless device 901 also includes memory 905. The memory 905 may be any electronic component capable of storing electronic information. The memory 905 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 907 and instructions 909 may be stored in the memory 905. The instructions 909 may be executable by the processor 903 to implement the methods disclosed herein. Executing the instructions 909 may involve the use of the data 907 that is stored in the memory 905.

The wireless device 901 may also include a transmitter 911 and a receiver 913 to allow transmission and reception of signals between the wireless device 901 and a remote location. The transmitter 911 and receiver 913 may be collectively referred to as a transceiver 915. An antenna 917 may be electrically coupled to the transceiver 915. The wireless device 901 may also include (not shown) multiple transmitters, multiple receivers, multiple transceivers and/or multiple antenna.

The various components of the wireless device 901 may be coupled together by one or more buses, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for broadcasting system overhead messages, the method being implemented by a base station, the method comprising:
generating a subpacket of system overhead messages that is designed so that a subscriber station improves a success rate of decoding the system overhead messages by accumulating multiple received subpackets; and
repeatedly broadcasting the subpacket to subscriber stations.

2. The method of claim 1, wherein less bandwidth is required to transmit the subpacket of the system overhead messages than to transmit the system overhead messages themselves.

3. The method of claim 1, wherein the subpacket is broadcast in accordance with a defined subpacket occurrence rate, and wherein the subpacket occurrence rate is greater than a defined overhead messages occurrence rate.

4. The method of claim 1, wherein the system overhead messages comprise a Downlink Channel Descriptor and an Uplink Channel Descriptor.

5. The method of claim 1, further comprising transmitting a DL-MAP information element (IE) that identifies a data burst within a downlink subframe in which the subpacket is transmitted.

6. The method of claim 5, wherein the DL-MAP information element is identified by an extended downlink interval usage code (DIUC) or an extended-2 DIUC code that is uniquely associated with the broadcasting of the system overhead messages.

7. The method of claim 5, wherein the DL-MAP information element comprises:
a medium access control (MAC) management message type;
a configuration change count;
a location of the data burst;
a size of the data burst; and
a modulation and coding scheme for the data burst.

8. A method for receiving system overhead messages, the method being implemented by a subscriber station, the method comprising:
combining a received subpacket of system overhead messages and one or more previously received subpackets of the system overhead messages; and
attempting to decode the system overhead messages from the combination of the received subpacket of the system overhead messages and the one or more previously received subpackets of the system overhead messages.

9. A base station configured for broadcasting system overhead messages, comprising:
a processor;
memory in electronic communication with the processor;
instructions stored in the memory, the instructions being executable by the processor to:
generate a subpacket of system overhead messages that is designed so that a subscriber station improves a success rate of decoding the system overhead messages by accumulating multiple received subpackets; and
repeatedly broadcast the subpacket to subscriber stations.

10. The base station of claim 9, wherein less bandwidth is required to transmit the subpacket of the system overhead messages than to transmit the system overhead messages themselves.

11. The base station of claim 9, wherein the subpacket is broadcast in accordance with a defined subpacket occurrence rate, and wherein the subpacket occurrence rate is greater than a defined overhead messages occurrence rate.

12. The base station of claim 9, wherein the system overhead messages comprise a Downlink Channel Descriptor and an Uplink Channel Descriptor.

13. The base station of claim 9, wherein the instructions are also executable to transmit a DL-MAP information element (IE) that identifies a data burst within a downlink subframe in which the subpacket is transmitted.

14. The base station of claim 13, wherein the DL-MAP information element is identified by an extended downlink interval usage code (DIUC) or an extended-2 DIUC code that is uniquely associated with the broadcasting of the system overhead messages.

15. The base station of claim 13, wherein the DL-MAP information element comprises:
a medium access control (MAC) management message type;
a configuration change count;
a location of the data burst;
a size of the data burst; and
a modulation and coding scheme for the data burst.

16. A subscriber station configured for receiving system overhead messages, comprising:
a processor;
memory in electronic communication with the processor;
instructions stored in the memory, the instructions being executable by the processor to:
combine a received subpacket of system overhead messages and one or more previously received subpackets of the system overhead messages; and
attempt to decode the system overhead messages from the combination of the received subpacket of the system overhead messages and the one or more previously received subpackets of the system overhead messages.

17. A base station configured for broadcasting system overhead messages comprising:
means for generating a subpacket of system overhead messages that is designed so that a subscriber station improves a success rate of decoding the system overhead messages by accumulating multiple received subpackets; and
means for repeatedly broadcasting the subpacket to subscriber stations.

18. The base station of claim 17, wherein less bandwidth is required to transmit the subpacket of the system overhead messages than to transmit the system overhead messages themselves.

19. The base station of claim 17, wherein the subpacket is broadcast in accordance with a defined subpacket occurrence rate, and wherein the subpacket occurrence rate is greater than a defined overhead messages occurrence rate.

20. The base station of claim 17, wherein the system overhead messages comprise a Downlink Channel Descriptor and an Uplink Channel Descriptor.

21. The base station of claim 17, further comprising means for transmitting a DL-MAP information element (IE) that identifies a data burst within a downlink subframe in which the subpacket is transmitted.

22. The base station of claim 21, wherein the DL-MAP information element is identified by an extended downlink interval usage code (DIUC) or an extended-2 DIUC code that is uniquely associated with the broadcasting of the system overhead messages.

23. The base station of claim 21, wherein the DL-MAP information element comprises:
a medium access control (MAC) management message type;
a configuration change count;
a location of the data burst;
a size of the data burst; and
a modulation and coding scheme for the data burst.

24. A subscriber station for receiving system overhead messages, comprising:
means for combining a received subpacket of system overhead messages and one or more previously received subpackets of the system overhead messages; and
means for attempting to decode the system overhead messages from the combination of the received subpacket of the system overhead messages and the one or more previously received subpackets of the system overhead messages.

25. A computer-program product for a base station to broadcast system overhead messages, the computer-program product comprising a computer-readable medium having instructions thereon, the instructions comprising:
code for generating a subpacket of system overhead messages that is designed so that a subscriber station improves a success rate of decoding the system overhead messages by accumulating multiple received subpackets; and
code for repeatedly broadcasting the subpacket to subscriber stations.

26. The computer-program product of claim 25, wherein less bandwidth is required to transmit the subpacket of the system overhead messages than to transmit the system overhead messages themselves.

27. The computer-program product of claim 25, wherein the subpacket is broadcast in accordance with a defined subpacket occurrence rate, and wherein the subpacket occurrence rate is greater than a defined overhead messages occurrence rate.

28. A computer-program product for a subscriber station to receive system overhead messages, the computer-program product comprising a computer-readable medium having instructions thereon, the instructions comprising:
code for combining a received subpacket of system overhead messages and one or more previously received subpackets of the system overhead messages; and
code for attempting to decode the system overhead messages from the combination of the received subpacket of the system overhead messages and the one or more previously received subpackets of the system overhead messages.
